(19) United States
(12) Patent Application Publication
(10) Pub. No.: US 2010/0287603 A1
(43) Pub. Date: Nov. 11, 2010

(54) FLEXIBLE IDENTITY ISSUANCE SYSTEM

(75) Inventors: Jan Alexander, Duvall, WA (US); Hervey Wilson, Bellevue, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/437,681

(22) Filed: May 8, 2009

(51) Int. Cl. H04L 9/32; G06F 21/00; G06N 5/02

(52) U.S. Cl. 726/6; 706/47

(57) ABSTRACT

Techniques for implementing flexible identity issuance systems to allow users to specify one or more evaluation processes to be carried out by the issuance system based on input identity information. These evaluation processes may be specified in any suitable manner to allow an issuance system to carry out any process for generating output identity information for a content consumer. In some embodiments, an evaluation process may be specified to the issuance system as a series of tasks to be carried out, where each task corresponds to a conditions and an action to be taken when the condition is met. In this way, an evaluation process may be simply and easily specified by what operations are to be carried out, rather than how the operations are to be carried out. An issuer may interpret the specification to determine a functional process for carrying out the tasks.

### BACKGROUND

Many content providing systems are adapted to evaluate a content consumer's identity when evaluating whether to provide content to the consumer and/or what type of content to provide to the consumer. For example, an Internet-accessible web service may require a user to log in and/or authenticate himself or herself before the web service will be provided to the user.

Identity information for a content consumer is traditionally provided to the content provider in one of several ways. In one conventional technique, a consumer provides directly to the provider identity information, such as a username and password. In another conventional technique, rather than providing identity information directly to the provider, a consumer requests that an identity issuance system—for example, one trusted by both the consumer and the provider—provide identity information to the provider that identifies the consumer. The identity information may be used by the provider to determine whether the consumer has the necessary permission(s) to access the content, or the identity information may identify the permissions the consumer has.

In a conventional identity issuance system, a consumer contacts a provider to request that content be provided to the consumer, and in response is instructed what type of identity information the provider requires to provide the content. The consumer then transmits to an issuer some initial information identifying the consumer to the issuer, which in turn outputs the identity information required by the provider. The consumer sends the output identity information to the provider and, if the identity information is correct, the provider provides the content to the consumer.

The operations of the issuer to produce output identity information are governed by the analysis process with which the issuer is configured. Conventional issuance systems have a limited range of operations and typically present an administrator with a set of options from which to select an issuance process. For example, an issuer may have a pre-established set of identity information which it provides (e.g., identity information the server's distributor considered to be most commonly used). As another example, an issuer may have a preconfigured set of analysis types from which an administrator must select when configuring the issuer. Thus, when designing an issuer and/or provider, an administrator of the issuer/provider must ensure that the requirements of the system conform to the available options and configuration of the issuer.

The options available for configuring the issuer may include outputting specific identity information when the initial identity information is of a particular type or has a particular value. In some cases, an issuer may be associated with a particular data store, such that when initial information is received additional information may be retrieved from the data store. For example, if a username is input, the issuer may retrieve permissions from the data store based on the username or a listing of user groups with which the username is associated. Information that is retrieved is output by the issuer as output identity information and sent to the consumer and/or the provider.

### SUMMARY

Conventional issuance systems are rigid and inflexible, and do not permit a user (e.g., an administrator) to specify freely analysis processes that will be performed by the system. Rather, a user is only permitted to select from pre-determined analysis processes to be performed. While some environments and systems may benefit from identity structures that do not conform to these predetermined formats or from identity analysis process that do not fit into these predetermined formats, they cannot use these structures or processes with conventional systems. Various advantages could be offered by systems that allow users to specify freely evaluation processes to be carried out by issuance systems on input identity information to produce output identity information.

Described herein are various techniques and principles for implementing flexible identity issuance systems to allow users to specify one or more evaluation processes to be carried out by the issuance system based on input identity information. These evaluation processes may be specified in any suitable manner to allow an issuance system to carry out any suitable task or tasks as part of the evaluation process.

In some embodiments, an evaluation process may be specified to the issuance system using a rules-based language in which the evaluation process is specified as a set of conditions and actions to be taken when the conditions are met. For example, a condition may specify that when input identity information contains a piece of information having a particular type or value (e.g., is a username, or is a particular username), a particular action should be taken. This action may include querying a specified data store.

Issuance systems that use evaluation processes as proposed herein—including some which are implemented with a rules-based language—may enable various functions to be performed as part of the evaluation processes. For example, complex processes may be used that evaluate multiple pieces of identity information to generate multiple pieces of output identity information, rather than only a one-to-one correspondence. As another example, multiple data stores may be used of different types, such that an evaluation process may retrieve information from any specified data store rather than only a single pre-configured store. In some cases, an issuance system may be able to produce output identity information that include values specified in input identity information, rather than only analyzing input information to produce different output. As a further example, an issuance system may be adapted to retrieve and process identity information as intermediate steps of an evaluation process, rather than only generating output in each step.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of one exemplary implementation of a system including an issuer operating according to techniques described herein;

FIGS. 2A and 2B illustrate exemplary computer systems in which the system of FIG. 1 may be implemented;

FIG. 3 is a flowchart of one exemplary process for configuring an issuer to operating according to techniques described herein;

FIG. 4A is a flowchart of one task that may be carried out by an issuer for retrieving information from a data store;

FIG. 4B is a flowchart of one task that may be carried out by an issuer for analyzing complex conditionals to determine whether to perform an action;

FIG. 4C is a flowchart of one task that may be carried out by an issuer for generating intermediate identity information is generated and not used as output;

FIG. 4D is a flowchart of one task that may be carried out by an issuer for using input identity information as output identity information;

FIGS. 5A to 5F are an example of an evaluation process operating according to techniques described herein that is implemented using a rules-based language; and

FIG. 6 is a block diagram of a computing device with which some embodiments of the invention may act.

### DETAILED DESCRIPTION

Conventional issuance systems were limited in functionality and did not well suit all situations and environments. When configuring a system, administrators of conventional issuance systems were only given a very small range of options and abilities for analyzing input information and generating output information. This was done to ensure that identity issuance systems could be configured and operated correctly and easily, preventing confusion or error on the part of the user.

For example, in some systems, an administrator would be able to generate a default set of output information based on input information, without configuration. Accordingly, in some instances, a user would provide as input information a username or other identifier, and a default set of output information would be generated regardless of the circumstances or the user.

Some other systems, however, did permit an administrator to customize and configure a system to generate output information as desired, though these systems were very limited in their ability to be configured. For example, an administrator could specify an analysis process that output specific information when specific input information was received. However, in specifying a policy, the administrator could only specify that a single piece of input information be analyzed to determine whether a single piece of output information should be generated. Complex relationships were not allowed. Further, where an administrator could specify policies, the policies only allowed for generating output information based on input information. No policies allowed for analyzing and/or retrieving further information to be weighed in determining whether to output identity information. In conventional systems, this information could also only be retrieved from a single data store with which the issuer was associated; for an enterprise network, typically an identity server such as one hosting Microsoft's Active Directory Domain Services. Conventional systems were still further limited only to outputting new information based on input information; no input information could be used as output information.

While most systems, in the interests of ease of use, did not provide the ability to customize fully the processes carried out by an issuer, some systems did permit sophisticated users to configure their issuance systems. However, these systems did not permit for simple and easy re-configuration. While unsophisticated users were able to configure their systems by only reciting the simple policies themselves and allowing the system to implement those policies programmatically, any user seeking to customize fully the analysis process was required to provide the issuer with a fully functional implementation of the desired policy, dictating precisely how the policy would be implemented such that the issuer need only execute provided instructions to implement the policy. Creating such functional implementations, however, had a higher knowledge bar, as administrators would need to know not only how to write the computer-executable instructions, but also how the issuer operates and how identity information could be analyzed and used. Accordingly, unsophisticated users and administrators that were not familiar with how to create such functional implementations were deterred from customizing their systems. Further, when a functional implementation was used, maintenance and modification of the issuer was thus limited to those sophisticated users who could understand the functional implementation (e.g., read computer instructions). An unsophisticated user, or even some sophisticated users, could be blocked from interacting with the issuer to perform maintenance and modification by the inability to read and understand the functional implementation to understand the policy that is being applied.

These and other limitations of conventional systems prevented some administrators from fully configuring their systems in the most effective manner, and even prevented some administrators from using such identity issuance systems at all.

Accordingly, various advantages could be offered by systems that provide a user (e.g., an administrator or other user) the ability to fully customize and configure an evaluation process to be followed by an identity issuance system when determining whether and how to output identity information. For example, by permitting such users to tailor identity issuance systems to fit their own environments and needs, more systems may be able to benefit from the advantages of identity issuance systems without sacrificing functionality or efficiency on content consumers and/or content providers.

Described herein are various techniques and principles for implementing a flexible identity issuance system that permits a user to specify an evaluation process to be carried out by the issuer in determining, based on initial identity information input to the issuer, one or more pieces of identity information to output from the system. In some embodiments of the invention, an issuer may be configured to implement the evaluation process by operating according to a specification that describes a series of tasks included in the process, which may be interpreted by the issuer (or another suitable component of a computer system) to identify a series of computer-executable instructions to implement the specified evaluation policy. In this way, rather than a user (e.g., an administrator) providing a programmatic implementation of an evaluation process, the user need only specify what tasks are included in the process and a functional process in accordance with the specification will be created for execution by the issuer.

As described below, in some embodiments of the invention that allow specification of tasks in this manner, the tasks of the evaluation process may be specified in terms of a series of rules comprising conditions and actions, in which an action is taken when conditions of a rule are met. These rules may, in some cases, be specified using a rules-based language such as the one described below, in which a user is permitted to specify an evaluation process by specifying what tasks are to be carried out, rather than how the tasks are to be carried out. It should be appreciated, however, that these rules may be specified in any suitable manner.

Further, various functions and abilities of exemplary flexible issuers are described below which may be used in evaluation processes regardless of whether they are rules-based and regardless of whether the issuer uses a rules-based language. For example, the ability to query any suitable data store, the ability to process complex conditions comprising multiple terms, the ability to use input values as part of output identity information, and the ability to calculate, retrieve, analyze, or otherwise use identity information in intermediate steps without outputting the intermediate identity information may be implemented in any suitable issuance system that does not support rules-based specification.

It should be further appreciated that the examples of identity information provided below are only illustrative of the types of identity information that may be processed by embodiments of the invention, and that other types are possible. “Identity information,” as used below, refers to any suitable type or types of information that may be used to identify a user, process, computer, device, or other component of a computer system, including information that may be used to determine or that may specify the permissions of the component of the computer system. Identity information may be stored and used in any suitable manner. In some embodiments of the invention, identity information may be structured as “claims,” each of which is associated with a particular piece of identity information. A claim may specify various properties and attributes of the piece of identity information, such as the type of identity information, the value of the identity information, and a source of the identity information, among other properties/attributes. In some embodiments of the invention that use claims, claims may be aggregated into a container known as a token, which itself may also include any suitable properties and attributes regarding the series of claims included in the token, such as identity information for a device or process that aggregated the claims into the token.

Examples of the types of techniques describes herein are given below which operate using claims. It should be appreciated, however, that claims and tokens are only an example of one way that identity information may be stored and used, and that identity information may be stored and used in any suitable manner.

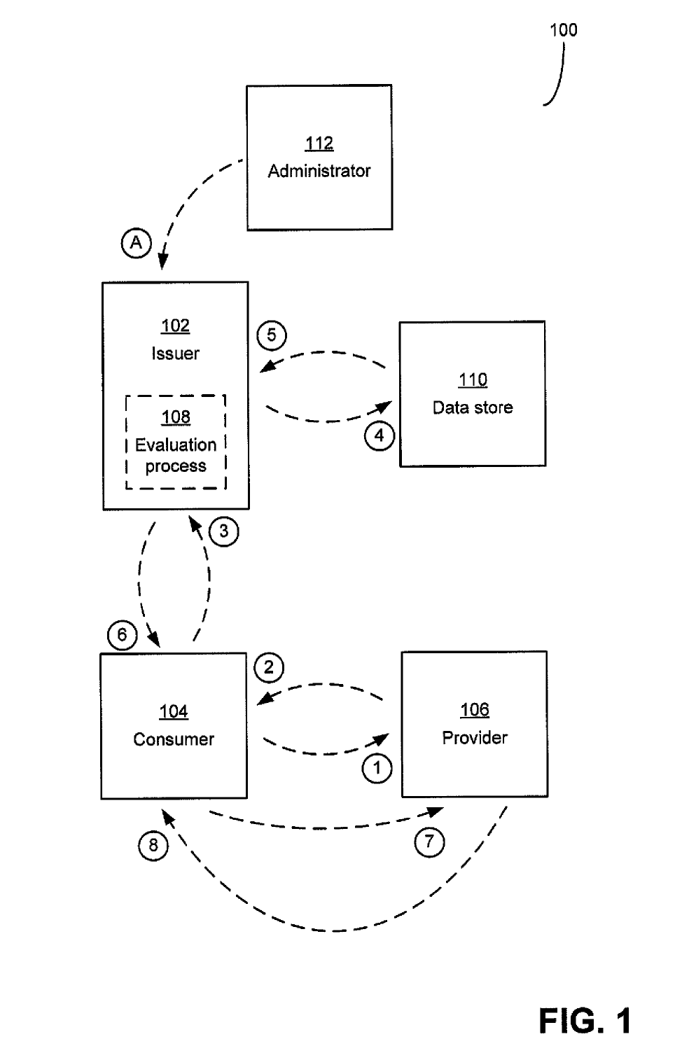

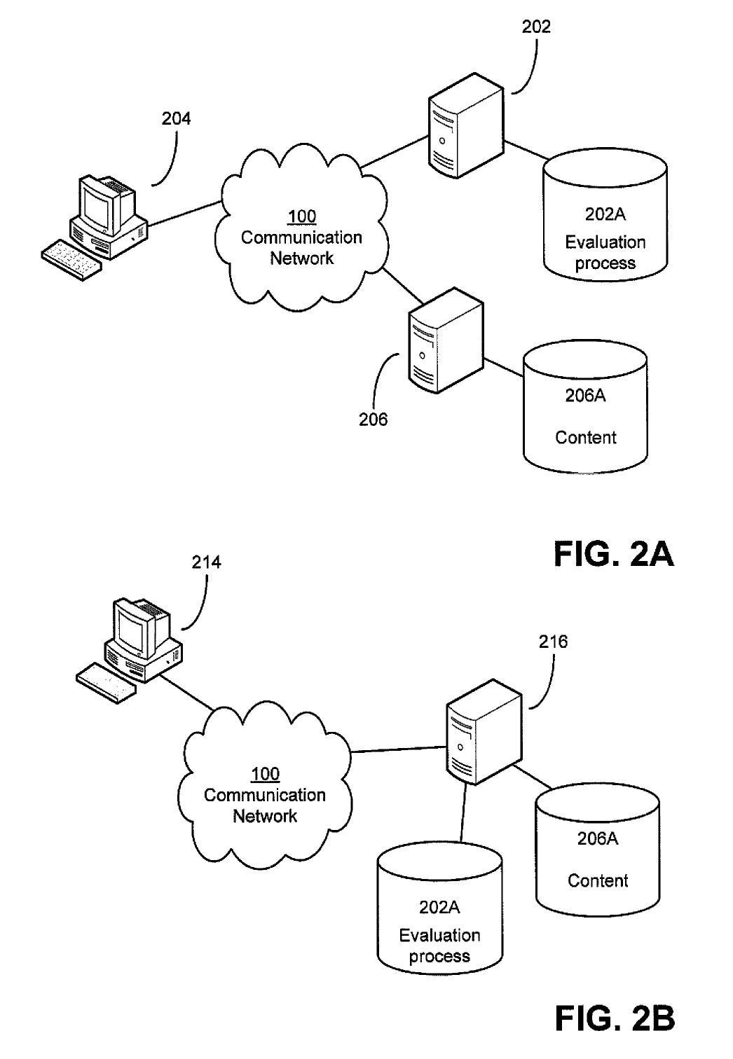

To provide context for the discussion below, FIGS. 1 and 2 illustrate exemplary systems in which embodiments of the invention may operate It should be appreciated, however, that embodiments of the invention are not limited to being implemented in any of these exemplary systems, as embodiments of the invention may be implemented in any suitable manner.

FIG. 1 shows a block diagram of components of one exemplary system 100, including an identity issuer 102, a content consumer 104, and a content provider 106. In some embodiments of the invention, a consumer 104 may desire content from provider 106, but provider 106 requires some indication of the identity of consumer 104 before provider 106 the content. Provider 106 may require this information for any suitable reason, such as auditing (e.g., keeping track of who/what is being provided content) or security (e.g., ensuring that consumer 104 has permission to access the content). In this case, consumer 104 may be any suitable component of a computer system, including a user, a process executing on a computing device, or a computing device, among others.

Consumer 104 may therefore in act 1 determine what identity information is needed by the provider 106 (e.g., by requesting and receiving in act 2 a specification of that identity information) and may in turn access identity issuer 102 to obtain the identity information. To do so, consumer 104 may provide initial identity information to the issuer 102 in act 3 that the issuer 102 may evaluate and use to create output identity information regarding the consumer 104.

The issuer 102, upon receipt of the initial identity information from the consumer 104, may perform any suitable evaluation process 108, examples of which are discussed below, to create the desired output identity information. For example, as shown in acts 4 and 5, the issuer 102 may retrieve identity information from a data store 110 and evaluate the retrieved identity information in determining whether and what type of identity information to provide as output identity information.

Issuer 102 may have been configured with evaluation process 108 in any suitable manner. In some cases, issuer 102 may have been configured by an administrator 112 prior to execution of the interactions shown in FIG. 1, as shown by act A. It should be appreciated that the administrator 112 may be any suitable user of the computer system, including one with administrative responsibilities and oversight for issuer 102 or a regular user, or may be any other suitable component of a computer system, such as a process or computing device.

Configuring issuer 102 with the evaluation process 108 may be done in any suitable manner to cause the issuer 102 to carry out any suitable tasks as part of determining whether and what type of identity information to provide as output. This may comprise specifying conditions and actions to be taken, which may be interpreted by the issuer 102 to determine a functional process for carrying out a policy including those tasks and that performs the specified actions upon fulfillment of the conditions. In some cases, as described in further detail below, the configuration of act A may further involve configuring the issuer 102 to communicate with one, two, or more data stores 110, as the issuer 102 may not be preconfigured to communicate with any external data stores. Rather, the administrator 112 may configure the issuer 102 to specify a manner in which the issuer 102 is to communicate with the one, two, or more data stores 110, after which, as part of evaluation process 108, the issuer 102 may retrieve identity information as outlined by the evaluation process 108.

Also as discussed below, in some cases the evaluation process 108 may involve calculating and/or retrieving intermediate identity information that may not be output as output identity information. Instead, intermediate identity information may only be used as part of the evaluation process 108 in determining whether identity information is to be output and what identity information is to be output. Accordingly, in some embodiments of the invention not all information that is received from the external data store 110 in act 5 may be output as output identity information.

Regardless of how the issuer 102 is configured, once an evaluation process 108 is complete and output identity information for the consumer 104 is determined, in act 6 the output may be provided to the consumer 104. In turn, the output identity information may be transmitted to the provider 106, which may evaluate the output identity information for the consumer 104 to determine whether the consumer 104 has permission to access the content. Determining whether the consumer 104 has permission may include reviewing the identity information received in act 7 to determine whether it indicates that the consumer 104 has permission, or may include retrieving any additional information (e g., permissions information) based on the identity information. If the consumer 104 is determined to have access, then in act 8 the content is provided to the consumer 104.

The system 100 illustrated in FIG. 1 can be implemented in any suitable computer system comprising any suitable number and type(s) of computing devices. Further, while components of system 100 are shown separately (e.g., issuer 102, consumer 104, and provider 106), in some embodiments of the invention these components may be implemented on the same computing device and even in the same process or application. For example, in some implementations all components of the system 100 may be implemented in one computer and/or one application.

FIGS. 2A and 2B show two examples of computer systems in which some embodiments of the invention may act. It should be appreciated, however, that these computer systems are merely illustrative, and that embodiments of the invention may operate in other computer systems.

FIG. 2A shows one system comprising a communication network 200 to which a plurality of computing devices are connected. The network 200 may be any suitable wired and/or wireless network over which computing devices may exchange information, including an enterprise network and/or the Internet. The computing devices connected to network 200 include a consumer computing device 204, an identity issuer server 202, and a content provider server 206. As shown in FIG. 2A, the issuer server 202 may be coupled to a data store 202A storing information describing an evaluation process that the issuer server 202 may execute and provider server 206 may be coupled to a data store 206A storing content information. Each of these computing devices may correspond to a component of the system 100, such that consumer device 204 may implement a content consumer 104, issuer server 202 may implement an issuer 102, and provider server 206 may implement a provider 106. These devices may communicate in any suitable manner, including the manner shown in FIG. 1.

FIG. 2B shows an alternative system, also including the communication network 200. The computer system of FIG. 2B shows a consumer 214 and a server 216 hosting both an issuer server and a provider server. As shown in FIG. 2B, server 216 it connected to two data stores 202A and 206A storing, respectively, an evaluation process and content to be provided. Accordingly, it should be appreciated that in some embodiments of the invention components of the system 100 may be executed by the same computing device.

While not shown in FIGS. 2A and 2B, in some environments a computer system may further comprise an administrator computing device that communicates information to other computing devices in the system, including an issuer server 202 or 216. The information communicated to the other computing devices may be configuration information that may cause the computing devices to operate in an intended manner, such as by executing a specified evaluation process.

It should be appreciated that while the computing devices of FIGS. 2A and 2B are illustrated as particular types of computing devices (e.g., consumer 204 is shown as a desktop personal computer, and issuer 202 is shown as a server), embodiments of the invention are not limited to operating with any particular type(s) of computing devices. Rather, components of the computer system may be implemented in any suitable manner. For example, consumer 204 could be a laptop personal computer, or a Personal Digital Assistant (PDA), or any other computing device adaptable to receive content from a provider 206, and issuer 202 may be any computing device adaptable to carry out an evaluation process.

As discussed above, configuration of an issuer 102 to carry out an evaluation process may be done in any suitable manner. In some implementations, an evaluation process may be specified to the issuer 102 as a specification of one or more tasks to be carried out as part of the evaluation process, rather than a recitation of an exact series of instructions to execute. When tasks are specified in this manner, the tasks may be interpreted by the issuer 102 to create a functional process for evaluating and outputting identity information. For example, in some cases tasks may be input to the issuer 102 as a specification of a condition and an action to be taken upon fulfillment of the condition. The issuer 102, upon receipt of the condition and action, may create a functional process comprising instructions for implementing the task, such as testing for whether the condition is met and, if so, implementing the action.

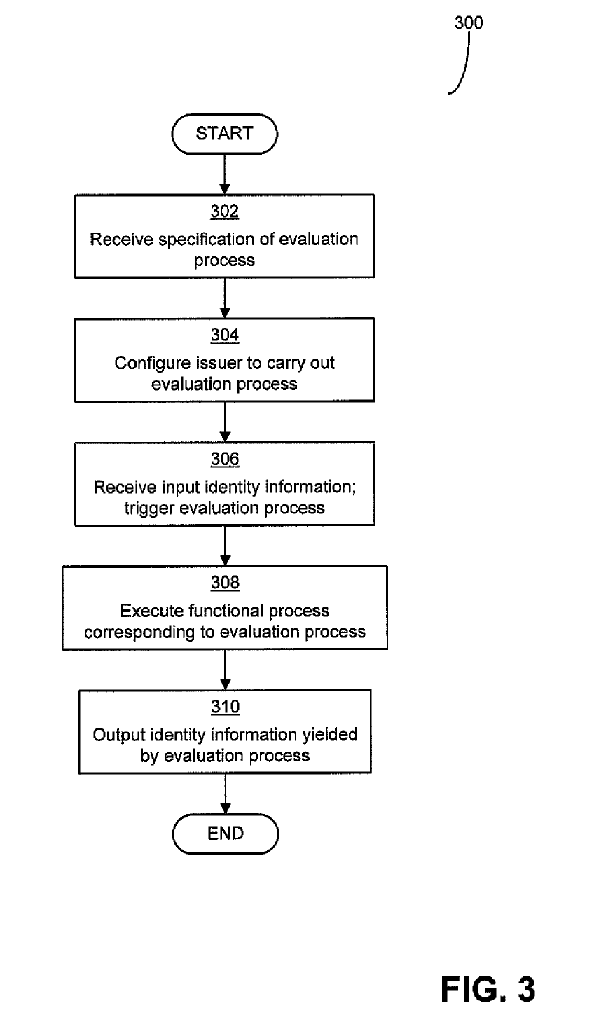

FIG. 3 shows one example of a process for configuring and using an issuer 102 by specifying at least one task to be carried out. It should be appreciated, however, that FIG. 3 is merely exemplary, and that other configuration processes—including other configuration processes that use tasks—are possible.

The process 300 of FIG. 3 begins in block 302, in which an administrator specifies at least one task to be carried out, such as by specifying a condition and an action to be taken based on that condition.

The condition may be any suitable condition, such as that a particular piece of identity information (e.g., a particular claim) that has been received or calculated by the system be of a particular type or have a particular value. In some cases, the condition of block 302 may have only one term, while other cases the condition may have multiple terms (e.g., that a claim be of a particular type and have a particular value). Further, as discussed further below, the condition may relate to initial identity information received by the issuer 102 from the consumer 104 and/or to any identity information that may have been generated by the issuer 102 or retrieved from an external data store.

In some cases, the condition for a task may always be satisfied, such as where the condition will always evaluate to “true” or where no condition is specified (e.g., where the condition is no condition). Accordingly, in some such cases, where no condition is specified or where the condition is always “true,” the action may always be carried out, regardless of input to the issuer or other actions taken by the issuer. It should be appreciated, then, that while some tasks and rules are described herein as having an action that is taken when a condition is satisfied, in some cases a condition may not be specified, such that the “condition” is always met and the action is always taken. Thus, in some implementations where a task may include information that describes a condition for the action of the task, that information may be blank, which may be interpreted as a condition that is always met.

The action specified in block 302 may similarly be any suitable action taken in relation to identity information. For example, the action may be one to generate a particular piece of identity information, such as by calculating new identity information based on previous identity information (e.g., forming a “name” claim by aggregating “firstname” and “lastname” claims). In other cases, the action may include outputting a particular piece of identity information, or retrieving identity information from an external data store. When identity information is to be retrieved from an external data store, the action may specify how the information is to be retrieved and what information is to be retrieved. For example, if the external data store is one that supports the Structured Query Language (SQL), the action may specify the particular data store to be queried and the SQL string to be used to query the data store. In some implementations, to query a data store, the issuer 102 may need to be configured to communicate with the data store, which may form a portion of the configuration of block 302 or may be a separate action.

Accordingly, in block 302, unlike previous implementations of identity issuance systems, an issuer 102 may be configured with an evaluation process that was freely specified without restraint on functionality. Previous implementations permitted only selecting functions to be carried out from a limited set of available functions; specifying tasks in block 302, however, allows for freely specifying the evaluation process.

Once the one or more specifications related to the one or more tasks of the evaluation process have been input to the issuer 102, in block 304 the issuer 102 may be configured to use the evaluation process when determining whether and what identity information is to be output when identity information is retrieved. This may comprise any suitable action, such as replacing a previously-used evaluation process or placing the specification(s) into a particular location in memory.

In block 306, once the issuer 102 is configured with the evaluation process specified in block 302, it may begin using the evaluation process to determine whether and what identity information to output. In block 306, initial identity information is received from a consumer 104, which may trigger the start of the evaluation process. Accordingly, in block 308, the issuer 102 may retrieve the evaluation process from memory and execute it. Executing the evaluation process may, in some cases, comprise retrieving from memory a functional process based on the evaluation process, which may have been created in block 304 when the issuer 102 was configured with the evaluation process, or in block 302 when the administrator specified the evaluation process and before it was input to the issuer 102. In other cases, executing the evaluation process in block 308 may comprise, upon receipt of initial identity information in block 306, creating the functional process for the evaluation process, such that the functional process is created at run-time. As discussed above, the functional process is created in any suitable manner by interpreting the tasks specified by the evaluation process of block 302 to carry out the action(s) when the condition(s) are fulfilled.

During execution of block 308, the evaluation process may identify one or more pieces of output identity information for the consumer 104, and may output these as claims or as any other suitable structure. Claims may be organized as a token. Upon output of the token, the token may be sent, in block 310, to the consumer 104, which may in turn provide it to the provider 106 to receive the content.

It should be appreciated, however, that in some cases, depending on the evaluation process and the environment in which it is implemented, the output generated and sent to the consumer 104 in block 310 may be a denial of identity information, such as where the initial identity information was determined to be faulty or fraudulent.

The evaluation process may specify any suitable type or types of tasks be carried out to yield output identity information. Examples of such tasks are given below, as well as, where applicable, configuration actions that may be needed in some systems to enable these tasks.

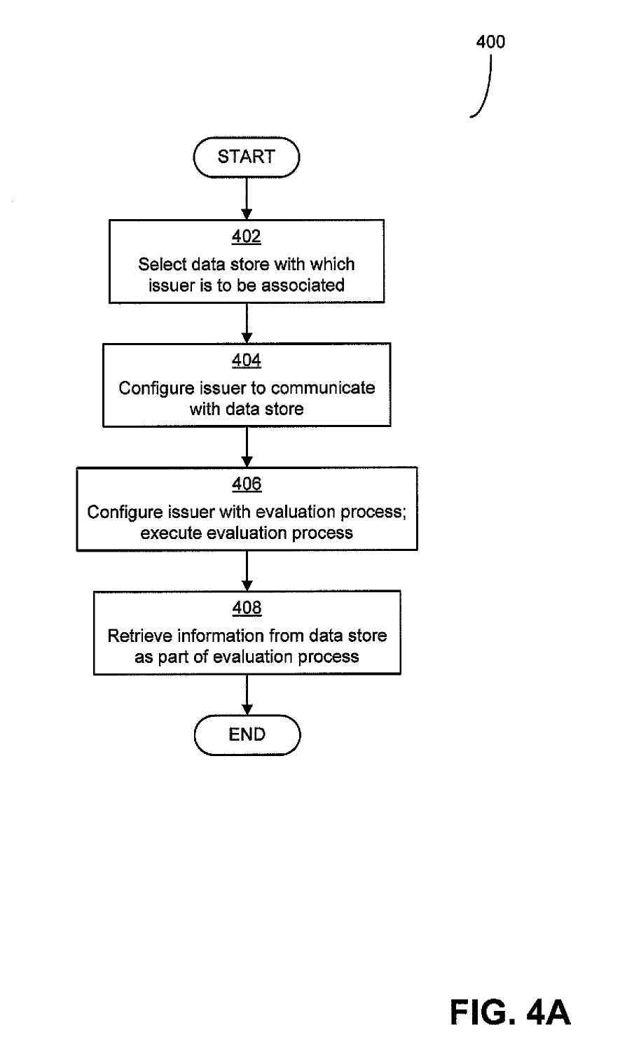

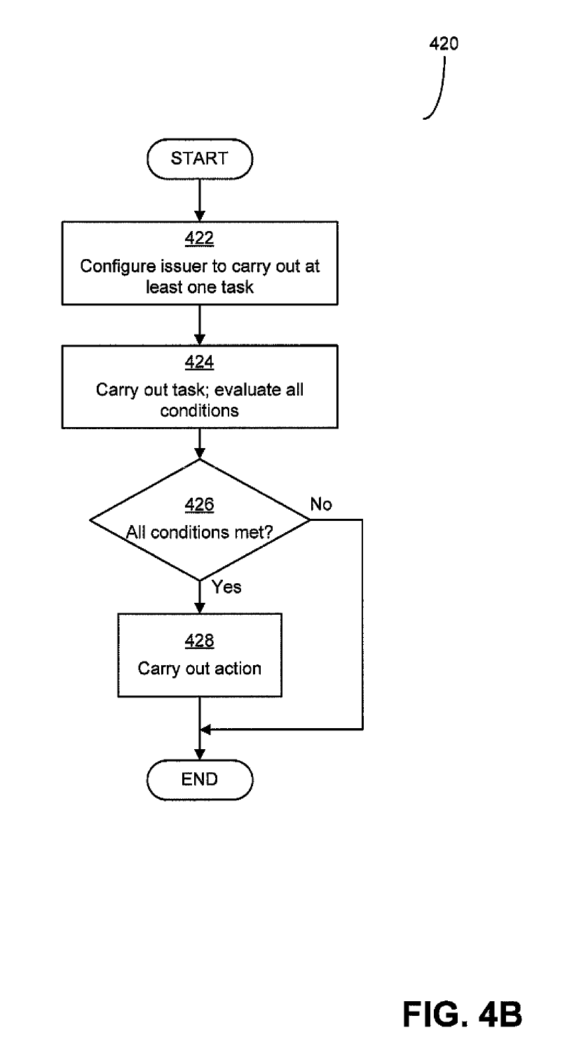

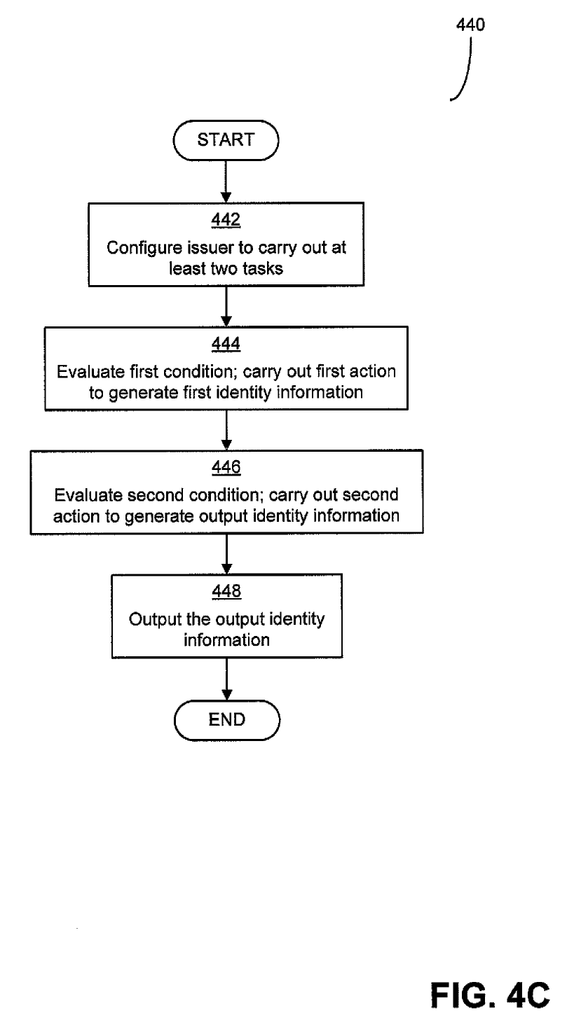

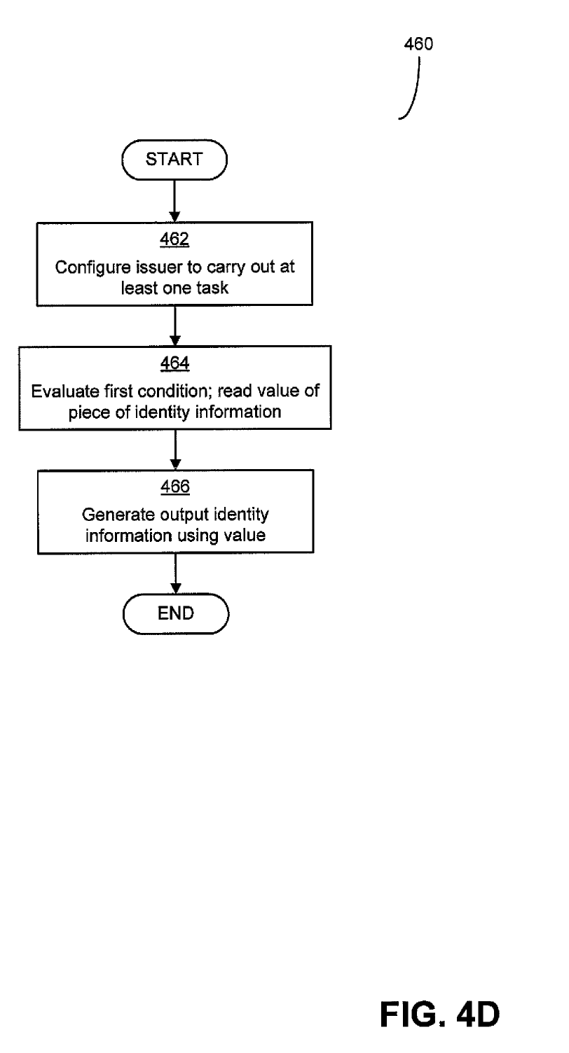

FIG. 4A shows an example of one such task. As discussed above, in conventional systems an issuer was associated with a particular data store and could only query that data store to produce output identity information. While this was done to make configuration of issuers simple and error-free, in some environments this unduly limited the type and amount of identity information that may be used in determining whether and what type of identity information to output, as administrators were limited to only the type of identity information stored by the particular associated data store. In embodiments of the invention, however, any suitable number or type of data store may be queried to produce output identity information. FIG. 4A shows one process that may be followed for a task that involves retrieving identity information from a specified data store.

Process 400 of FIG. 4A begins in block 402, in which an administrator selects a data store with which the issuer 102 should be associated. The data store may store any suitable data that may be related to a consumer, including information directly corresponding to an identity of the consumer (e.g., username, email address, age, IP address, usergroups, etc.) as well as information indirectly corresponding to the identity of the consumer (e.g., permissions). In block 404, the administrator may configure the issuer 102 to communicate with the data store, such as by installing device drivers or configuring it with information such as a location on a network with which the issuer 102 can communicate.

In block 406, the issuer 102 may be configured with an evaluation process that includes retrieving identity information from the data store, and may execute the process. The task that specifies that information should be retrieved may also specify what information is to be retrieved and a manner in which to retrieve it. For example, the action associated with the task may include a description of tables and fields of the data store that may be used to retrieve information, or a search query to be used in retrieving information. In block 408, this information may be used, together with the configuration information of block 404, to communicate with the external data store and retrieve information.

FIG. 4B shows an example of a second type of task that may be carried out, in which complex conditions are evaluated to determine whether to perform an action. Prior issuance systems provided only the ability to evaluate a single piece of identity information when determining whether to output a single piece of identity information. More complex conditions, such as those that specify multiple conditions for a piece of identity information or specify conditions for multiple pieces of identity information, were not possible. This simplified the configuration process for issuers, but also limited the freedom of administrators to customize their issuers, and limited the usefulness of the issuers. In embodiments of the invention, however, a process like process 420 shown in FIG. 4B may be implemented to permit such complex conditions in evaluation processes.

Process 420 begins in block 422, in which an issuer is configured to carry out a particular task based on a condition and an action. In block 424, the task is carried out by the issuer and it is determined whether the condition is met. This may comprise evaluating multiple conditions to determine whether identity information that was received as input and/or previously retrieved or generated matches the conditions. Further, where multiple conditions are used, conditions may apply to two or more pieces of identity information. For example, a condition may specify that a first piece of identity information be of a specified type and a second piece of identity information have a specified value. Any suitable combination of conditions may be used, where previously only one condition was permitted.

In block 426, it is determined whether all of the conditions specified in the task are met. If not, then the process ends. If so, then in block 428 the action specified in the task is taken, and the process ends.

In some embodiments of the invention, the complex conditions evaluated in the flowchart of FIG. 4B may include conditions relating to identity information previously retrieved and/or generated by an evaluation process. This is because in some implementations an issuer may be adapted to generate intermediary identity information that may not be input identity information and may not be used as output identity information; rather, the intermediate identity information may be used to evaluate conditions in further tasks and be used in actions of the further tasks to generate more identity information.

As discussed above, conventional issuers did not allow for generation of intermediary identity information. Instead, information that was retrieved or generated by the issuer was always used as output identity information, and could not be evaluated to determine further what types of identity information to output. In some embodiments of the invention, however, intermediate identity information may be generated or retrieved and used in evaluating conditions or taking actions.

FIG. 4C, accordingly, illustrates a third example of a type of task that may be supported by some embodiments of the invention, in which intermediate identity information is generated and used. The process 440 of FIG. 4C begins in block 442, in which an issuer is configured to carry out at least two particular tasks, each including a condition and an action. In block 444, a first task is carried out that evaluates a first condition against input identity information and determines that the first condition is met, so a first new piece of identity information is generated. This identity information is not output by the issuer 102, however. In block 446, a second task is carried out that evaluates a second condition that evaluates the identity information generated by the first task. When the second condition is met, another action is taken that produces some output identity information. The output information is output in block 448 and the process 440 ends.

In this simple example, information was generated by the first action that would meet the second condition, and a more efficient process may have generated that output based on the first condition. This may not always be the case, however In some tasks, a query of a data store may be carried out (such as by the process 400 shown in FIG. 4A) by a first action if a first condition is met, and the results of that query may not be output but instead may be analyzed to determine if output may be generated. For example, in one process, if input identity information contains a username, a query may be carried out to determine what user groups the user is in; if the user is found to be a part of a particular group, then output may be generated identifying the user has one who has permission to carry out a particular task.

FIG. 4D shows an example of a fourth type of task that may be carried out, in which input values are used to produce output identity information. Conventional issuance systems did not allow for input identity values (e.g., specific usernames, or other values) to be used in creating output identity information. Rather, the only information that could be output was information generated or retrieved by the issuer. This limited the utility of issuers and prevented their use in some situations where it would be useful to copy some input values to the output identity information to be passed to the provider.

Process 460 of FIG. 4D begins in block 462, in which an issuer is configured to carry out a particular task which includes an action. The action, in this case, uses a value of input identification information. In block 464, when it is determined that the condition associated with the task/action is met, a value for a piece of identity information is read from the identity information and, in block 466, used to generate and/or retrieve identity information. For example, the value for the piece of identity information may be used as part of a query for a data store to retrieve identity information or in generating a piece of identity information (e.g., (e.g., forming a “name” claim by aggregating the values for a “firstname” piece of identity information and a “lastname” piece of identity information). Once the identity information is produced, the process 460 ends.

By implementing an issuer 102 that allows for free configuration using an evaluation process specified by a series of tasks, and that evaluates those tasks to create a functional process for carrying out the evaluation process, a more flexible issuer that may be useful in more environments and systems may be achieved. Further, by implementing the issuer to be able to support tasks such as retrieving information from any available data store, or evaluating complex conditions, or generating and using intermediary identity information rather than only generating output, or by using input identity information as output identity information or to generate output identity information, more flexible systems may be generated.

It should be appreciated, however, that while various examples of the types of tasks that may be used in evaluation processes have been given, embodiments of the invention may implement any suitable task and are not limited to implementing or supporting these or any other type of task. Accordingly, embodiments of the invention may implement some, all, or none of the exemplary types of tasks shown above.

Further, embodiments of the invention may specify and carry out tasks in any suitable manner. In some embodiments of the invention, an evaluation process comprising a series of tasks may be specified to an issuer 102 using a rules-based language that specifies rules for each task, including a condition (which, as discussed above, may be a blank condition that is always satisfied) and an action to be taken on fulfillment of the condition.

A rules-based language may be implemented in any suitable manner. In some implementations, a rules-based language may be tied to the claim data structure, such that each condition and each action relates to claims that already exist or are to be generated. For example, each condition may relate to a claim such as by determining the type of the claim, the value of the claim, or the source of the claim, and each action may relate to a claim by generating a claim based on, for example, calculating or retrieving information to form the basis of the claim.

One example of an issuer 102 that operates according to a rules-based language is described below. It should be appreciated, however, that this rules-based language is only one example of the types of rules-based languages that may be used in embodiments of the invention, and further that embodiments of the invention are not limited to being implemented with rules-based languages.

An evaluation process, when implemented using a rules-based language as a set of rules corresponding to tasks, may be considered a set of instructions that transforms or filters input identity information at each step. For example, when a token (i.e., a set of one or more claims) is received as input, the token may be subjected to each rule of the rules. If the token satisfies the condition of tie rule, then the token may be transformed by the action portion of the rule. The action portion may include adding or removing claims from the token, including manipulating claims of the token to generate additional claims.

For example, a set of simple rules associated with two tasks is:

| | | |
|---|---|---|
| [type | == | “Name”, value == “DNAME\uname”] |
| | => | add( type = “Role”, value = “Editor”); |
| [type | == | “Role”, value == “Editor”) |
| | => | issue( type = “Permission”, value = “ReadWrite”); |

In this example, upon receipt of an input token the evaluation process will determine whether the token includes a claim having the type “Name” (which may specify the user's name) and having the particular value “uname” in the domain “DNAME.” If the token does include a claim having those characteristics, then the condition is fulfilled and an action may be taken to add a claim to the token that has the type “Role” and the value “Editor.” In the next line it is determined whether the token includes a claim that has the type “Role” and the value “Editor”—which the token would, if the first condition were fulfilled—and if so then an action is taken to add a claim to the token having the type “Permission” and the value “ReadWrite.” This latter claim may be then used, when the token is output at the conclusion of the process, to signal that user “uname” has ReadWrite permission to the content.

As discussed above, in some embodiments of the invention intermediary pieces of identity information (e.g., intermediary claims) may be generated by an issuer 102 that are not used as output; rather, the intermediary claims are only used in determining whether output is to be generated. Accordingly, as shown in the example above, when claims are generated they may be treated in different ways by use of an “add” function or an “issue” function. In the former, claims may be made available for evaluation but will not be output by the issuer 102 and sent to the consumer 104; rather, they will only be used in evaluating further conditions (as shown in the second condition) or used in generating other claims. Claims that are generated using the “issue” function, however, may be used as output identity information. In some embodiments of the invention that use a rules-based language, during execution an evaluation process may be considered to operate with three different tokens (i.e., sets of claims): an input token, including claims initially input by the consumer to the issuer; an evaluation token, containing input claims and claims generated or retrieved during the evaluation process; and an output token, containing claims that have been specified by the output process as those that should be returned to the consumer.

As discussed above, in some cases multiple terms may be included in a condition, rather than only one term. When a rule having this condition is implemented in the rules-based language described herein, it may be specified as:

| | | |
|---|---|---|
| [type | == | “Group”, value == “Users”] && |
| [type | == | “AuthenticationType”, value == “SmartCard”] |
| | => | add( type = “Role”, value = “Editor”); |

In this example, claims (e.g., claims of an input token or claims of an evaluation token) may be compared to the conditions to see if a claim of the “Group” type and having the value “Users” and a claim of the “AuthenticationType” and having the value “SmartCard” are pending in the system. If both conditions are met, then a new claim having the type “Role” and the value “Editor” is created. As discussed above, the action may involve adding the claim to the evaluation token rather than outputting the new claim, because it is being performed with an “add” operation rather than an “issue” operation.

In each of the previous examples, the conditions were general ones that sought whether a claim meeting the criteria existed. A rules-based language may also support variables that map to claims that meet the specified criteria, such that the attributes and values of these claims may be used for further processing. This syntax may be expressed as:

c: [CONDITION]

In this case, when a claim matches the condition, the claim will be mapped to the variable c for further use. For example, here is one rule that implements a task for querying a data store when a claim arrives specifying a name:

| c:[type == “Name”] | | |
|---|---|---|
| => issue( | store | = “MySQLStore”, |
| | types | = (“Email”, Age”), |
| | query | = “SELECT email, age FROM users |

| | WHERE name=’{0}’”, |
|---|---|
| param | = c.value); |

In this example, the data store is queried with the specified SQL statement when a claim arrives that specifies a name for a consumer. Two pieces of identity information are requested in the query—the e-mail address and age associated with the name—and are mapped to two claims having the specified types upon arrival. The query specified by the action also makes use of the value of the claim having the Name type, by specifying that the value of the claim (c.value) is the parameter referred to in the query. As shown, the parameters specified in the action match the order to which they are referred in the action, zero-indexed. In this way, the parameter specified by “{0}” matches the first parameter, which is c.value.

In this exemplary rules-based language, claims can also be mapped to multiple parts of a condition and values of a claim can be used in specifying conditions, as shown in this example:

c1:[type == “FirstName”] && c2:[type == “LastName,” issuer=c1.isser]
=> issue( type == “Name”, value = c1.value + “ “ + c2.value);

In this case, C1 is mapped to a claim of type “FirstName” (specifying a first name for a user) and C2 is mapped to a claim of type “LastName” (specifying a last name for the user). The condition further stipulates that the source of the second claim (the issuer of the claim) must be the same as the issuer of the first claim. If all conditions match, then an action is carried out that generates a new claim of type “Name” and having a value that is a concatenation of the first and second claims.

As shown in these various examples, the rules-based language may enable the specification of a claim having any suitable attributes, and those attributes may include any suitable values. For example, as shown the “type” attribute for a claim may take any value that is specified by the action. This enables further the customization of the issuer that is performing an evaluation process based on the rules-based language. Rather than constraining claims to take only specified values or hold only specified attributes, any suitable data may be used and the issuer can be more closely tailored to the needs of the system and environment in which it is implemented.

When a rules-based language such as this is implemented and an evaluation process is specified that includes multiple rules, there are various ways to implement a system that chooses which rules to evaluate and when. For example, different implementations may update a status of the system at different times, such as applying all rules on a first state of the system, then updating the variable space upon completion and re-running all the rules. One simple manner of execution is to apply the rules sequentially to each input token that is received and update the system state at the completion of each rule.

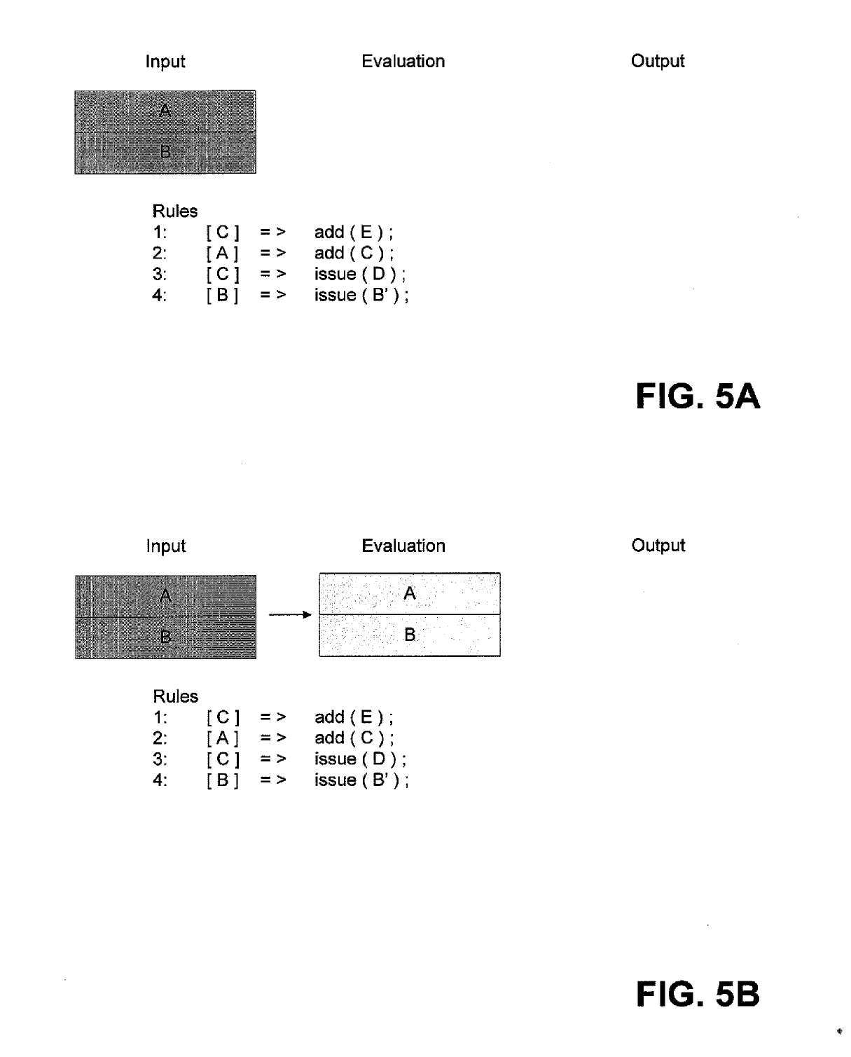

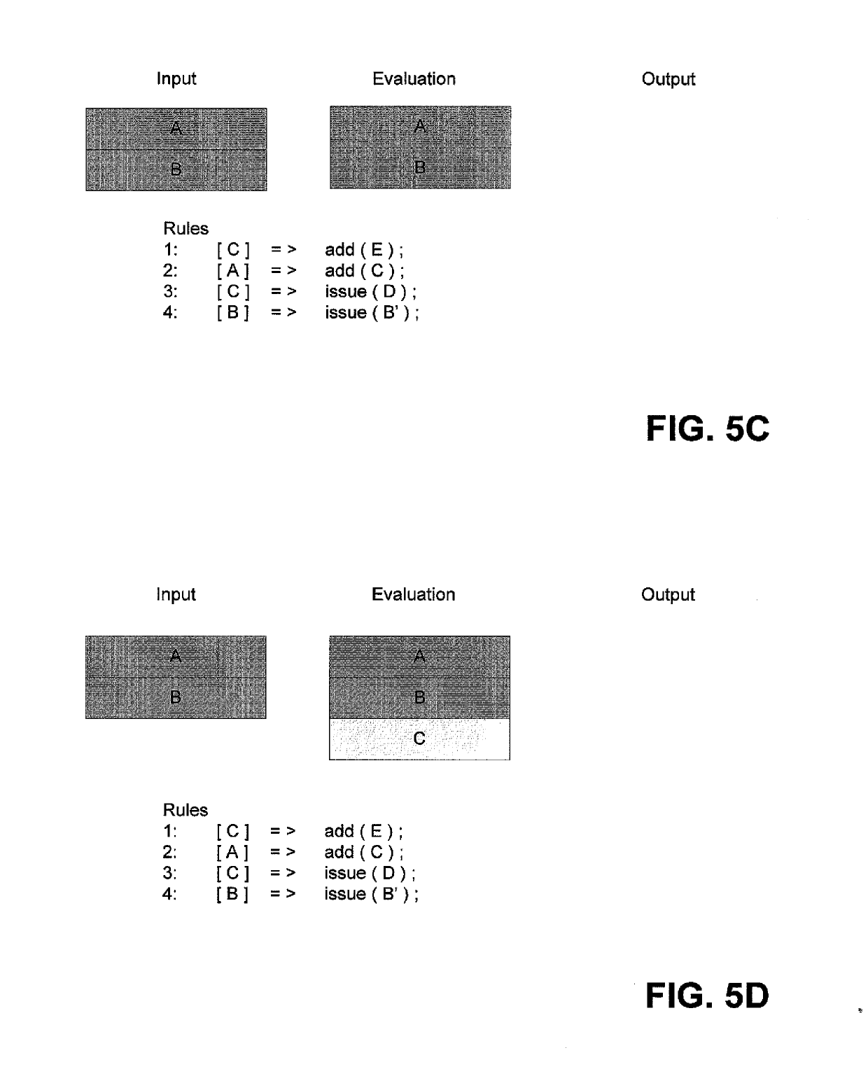

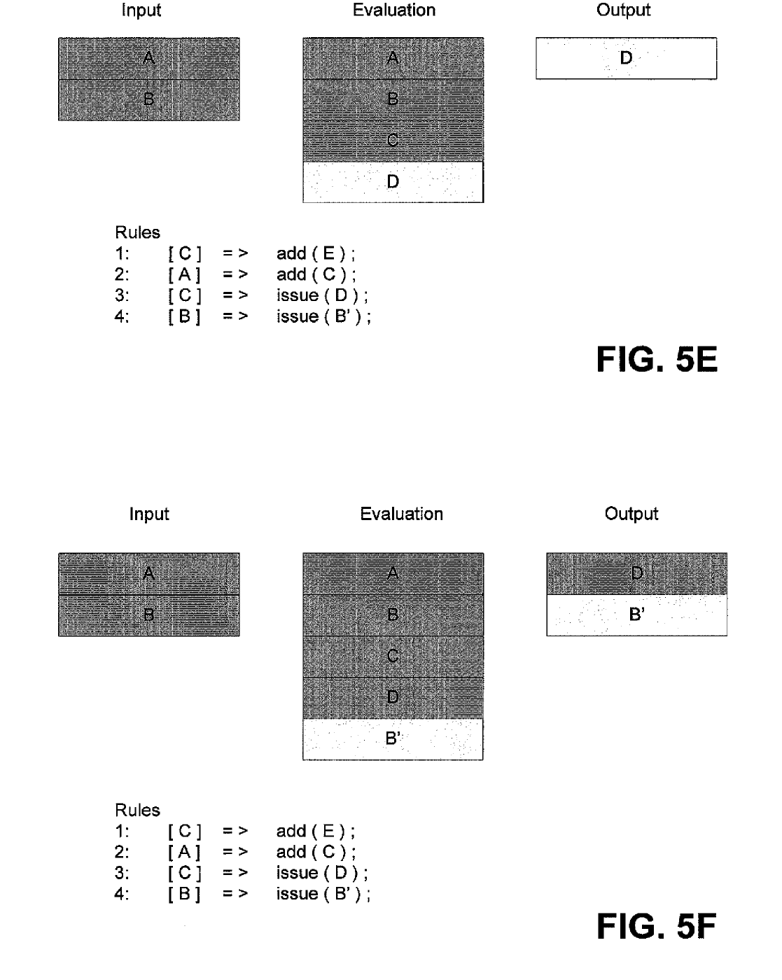

FIGS. 5A to 5F show one example of a process specified using a rules-based language, and how the rules may be evaluated sequentially to yield output values. The example of FIGS. 5A to 5F includes four rules, which are carried out in order to evaluate the input claims and generate evaluation claims and output claims. Following the execution of each action, the state of the system is updated such that a next rule can operate on changes made by a previous rule.

In FIG. 5A, an issuer receives as input a token comprising two claims: A and B. As shown, when input is initially received, no claims exist in the evaluation and output tokens. In FIG. 5B, the issuer begins operation by copying to the evaluation token the claims received in the input token; this is done because in this implementation the rules are only applied to claims contained within the evaluation context, which may be considered the working space, though other implementations are possible.

In FIG. 5C, a first rule is evaluated, which has a condition that matches a claim C. As shown in FIG. 5C, no claim exists in the evaluation token that matches this condition; only claims A and B exist, and not claim C. Because the condition is not met, the action is skipped (i.e., claim E is not added to the evaluation context).

In FIG. 5D, the second rule is next evaluated, which has a condition that matches claim A. Because claim A satisfies that condition, the action corresponding to that action is carried out; namely, claim C is added to the evaluation token. It should be appreciated at the “add” function is used here. As discussed above, the add function may add claims to the evaluation token, but not to the output token. Instead, an “issue” function may be used to add claims to the output token. In this way, claims may be generated and used that are not output from the system.

Here one example of an alternative implementation may be clear; a claim C now exists in the evaluation context, which matches the first rule, and as such in some implementations the first action may now be carried out. However, in this implementation rules are carried out sequentially in forward order, once every time input claims are received. Accordingly, in this implementation the first rule is still not applied, as it has already been applied. Rather, the next rule (rule 3) is executed.

In FIG. 5E, the third rule is carried out, which also matches the claim C. In this case, unlike the first rule, the claim C matches the condition. Accordingly—unlike conventional systems where analysis processes only operated on input identity information—the condition may be determined as met because the claim had been previously generated. Thus, the corresponding action is carried out; namely, a claim D is issued. Because the claim D is issued, it is added to the output token and prepared to be output from the system. Also, because it has been generated by the system, the claim D is added to the evaluation token so that it can be used in future operations.

In FIG. 5F, the fourth rule is carried out, which has a condition that matches the claim B. Because the condition is met, the action is taken, and a claim B′ is issued, which adds it to both the evaluation token and the output token.

Once the fourth rule is completed, the evaluation process of this example is complete. The output token is therefore output by the system, which may comprise sending the output token back to the consumer that requested that the operation be carried out or, in some cases, sending the output token to a content provider.

Using a rules-based language such as this one allows for specifying rules that can carry out any particular operation or task that is desired by an administrator. Accordingly, by supporting the specification of an evaluation process in this manner, an issuer can be made flexible and able to carry out any possible evaluation process, rather than only a predetermined set of operations.

Further, using a simple, rules-based language like the one described above offers the ability to specify rules for an evaluation process quickly, clearly, and easily. Administrators with limited experience in writing software code can therefore learn easily the necessary language and syntax to configure their systems and write code that is readable by unsophisticated individuals. This allows more administrators to customize the system, and makes an issuer more flexible.

Techniques operating according to the principles described herein may be implemented in any suitable manner. Included in the discussion above are a series of flow charts showing the steps and acts of various processes that make an issuer more flexible by permitting specification of any suitable evaluation process. The processing and decision blocks of the flow charts above represent steps and acts that may be included in algorithms that carry out these various processes. Algorithms derived from these processes may be implemented as software integrated with and directing the operation of one or more multi-purpose processors, may be implemented as functionally-equivalent circuits such as an Application-Specific Integrated Circuit (ASIC), or may be implemented in any other suitable manner. It should be appreciated that the flow charts included herein do not depict the syntax or operation of any particular circuit, or of any particular programming language or type of programming language. Rather, the flow charts illustrate the functional information one of ordinary skill in the art may use to fabricate circuits or to implement computer software algorithms to perform the processing of a particular apparatus carrying out the types of techniques described herein. It should also be appreciated that, unless otherwise indicated herein, the particular sequence of steps and acts described in each flow chart is merely illustrative of the algorithms that may be implemented and can be varied in implementations and embodiments of the principles described herein without departing from the invention.

Accordingly, in some embodiments, the techniques described herein may be embodied in computer-executable instructions implemented as software, including as application software, system software, firmware, middleware, or any other suitable type of software. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations needed to complete execution of algorithms operating according to these techniques. For example, one or more functional facilities may be implemented that accept as input a specification of tasks that are to be carried out as part of an evaluation process and create as output a functional process that implements those tasks. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package, for example as a software program application such as the Geneva Server available from the Microsoft Corporation of Redmond, Wash., or other system operating as a security token service (STS) of an identity system. These functional facilities may, in alternative embodiments, be adapted to interact with other, unrelated functional facilities and/or processes, to implement a software program application. In other implementations, the functional facilities may be adapted to interact with other functional facilities in such a way as form an operating system, including the Windows operating system, available from the Microsoft Corporation of Redmond, Wash. In other words, in some implementations, the functional facilities may be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that may implement the exemplary techniques described herein, and that the invention is not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

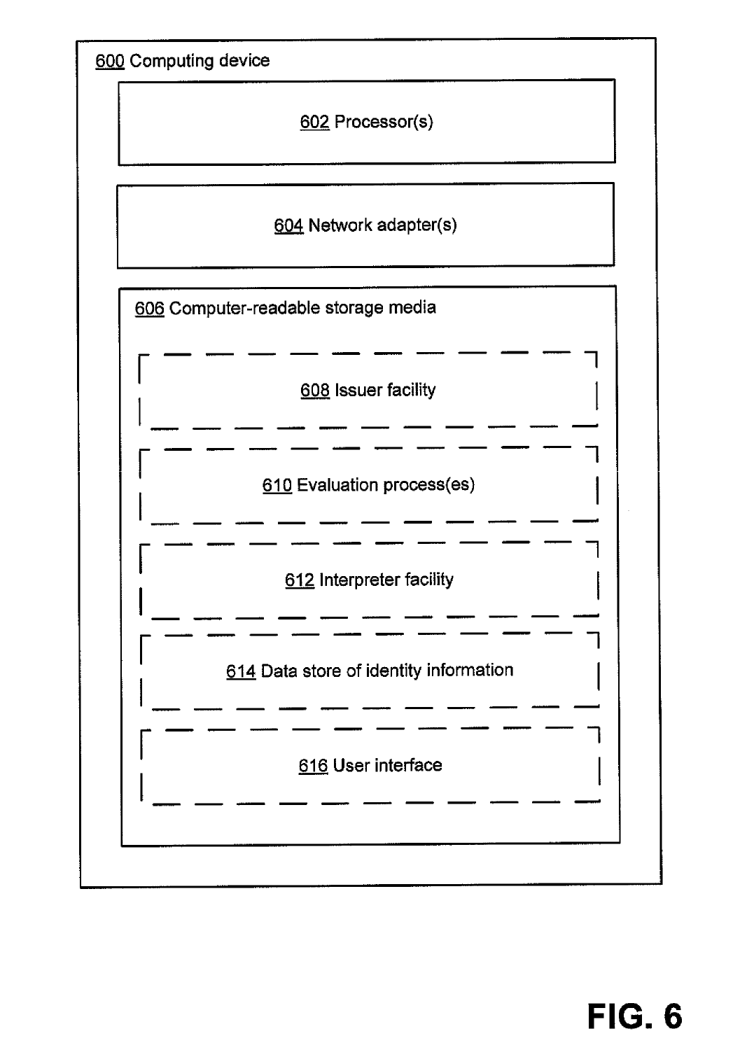

Computer-executable instructions implementing the techniques described herein (when implemented as one or more functional facilities or in any other manner) may, in some embodiments, be encoded on one or more computer-readable storage media to provide functionality to the storage media. These media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable storage medium may be implemented as computer-readable storage media 606 of FIG. 6 described below (i.e., as a portion of a computing device 600) or as a stand-alone, separate storage medium. It should be appreciated that, as used herein, a “computer-readable media,” including “computer-readable storage media,” refers to tangible storage media having at least one physical property that may be altered in some way during a process of recording data thereon. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques-such as implementations where the techniques are implemented as computer-executable instructions-the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, including the exemplary computer system of FIGS. 2A or 2B. Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 6 illustrates one exemplary implementation of a computing device in the form of a computing device 600 that may be used in a system implementing the techniques described herein to implement an issuer, although others are possible. It should be appreciated that FIG. 6 is intended neither to be a depiction of necessary components for a computing device to operate in accordance with the principles described herein, nor a comprehensive depiction.

Computing device 600 may comprise at least one processor 602, a network adapter 604, and computer-readable storage media 606. Computing device 600 may be, for example, a desktop or laptop personal computer, a stand-alone or rack-mounted server, a mainframe or any other suitable computing device. Network adapter 604 may be any suitable hardware and/or software to enable the computing device 600 to communicate wirelessly with any other suitable computing device over any suitable computing network. The computing network may include a wireless access point as well as any suitable wired and/or wireless communication medium or media for exchanging data between two or more computers, including the Internet. Computer-readable media 606 may be adapted to store data to be processed and/or instructions to be executed by processor 602. Processor 602 enables processing of data and execution of instructions. The data and instructions may be stored on the computer-readable storage media 606 and may, for example, enable communication between components of the computing device 600.

The data and instructions stored on computer-readable storage media 606 may comprise computer-executable instructions implementing techniques which operate according to the principles described herein. In the example of FIG. 6, computer-readable storage media 606 stores computer-executable instructions implementing various facilities and storing various information as described above. Computer-readable storage media 606 may store an issuer facility 608 for carrying out processes and functions related to the processing of identity information and production of output identity information. The computer-readable storage media 606 may also store one or more evaluation processes 610 that may be carried out by the issuer facility 608, as well as an interpreter facility 612 for interpreting the evaluation process 610 when the process 610 is specified as a series of tasks describing what operations are to be carried out, rather than how. The interpreter 612 may yield as output a functional process that can be executed by the issuer facility 608. Interpreter 612 may be implemented in any suitable manner, including as a compiler for a programming language, such as a rules-based language like the one described above.

Computer-readable storage media 606 may further store any suitable data store 614 of identity information that may be used to evaluate input identity information and generate output identity information. As shown in FIG. 6, the computer-readable storage media 608 may also include a user interface 616 by which the evaluation process(es) 610 may be specified and by which the issuer 608 may be configured. Though, in some embodiments of the invention, the evaluation process(es) 610 may not be specified by a local user interface, but rather may be specified remotely, such that the evaluation process(es) 610 may be received via the network adapter 604.

While not illustrated in FIG. 6, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments of the invention have been described where the techniques are implemented in circuitry and/or computer-executable instructions. It should be appreciated that the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A method of configuring an identity issuance system to process identity information according to a specified evaluation process, the method comprising:
(A) receiving a specification describing at least one task to be carried out in processing the identity information as part of an evaluation process, the specification describing a condition and an action to be taken upon fulfillment of the condition;
(B) interpreting the specification received in the act (A) to determine a functional process for how to carry out the at least one task; and
(C) configuring the identity issuance system to carry out the functional process upon receiving input identity information.

2. The method of claim 1, wherein the condition is that two or more pieces of identity information correspond to predetermined values.

3. The method of claim 2, wherein the two or more pieces of identity information includes identity information not received as input identity information.

4. The method of claim 1, wherein the action comprises retrieving additional identity information from an external data store when the condition is met, the external data store being specified by the action.

5. The method of claim 4, further comprising:
receiving a communication protocol specification for the external data store, the communication protocol specification describing a manner in which information is to be requested and received from the external data store; and
configuring the claims issuance system to communicate with the external data store according to the communication protocol specification.

6. The method of claim 1, wherein the action comprises assembling an output token comprising output identity information, wherein the output identity information comprises at least some of the input identity information.

7. The method of claim 1, wherein the action comprises generating at least one piece of intermediate identity information that is not output as output identity information.

8. The method of claim 7, wherein generating comprises retrieving the at least one piece of intermediate identity information from an external data store.

9. The method of claim 1, further comprising:
receiving the input identity information;
evaluating the input identity information to determine whether the condition is fulfilled; and
if the condition is fulfilled, carrying out the action.

10. At least one computer-readable storage medium encoded with computer-executable instructions that, when executed, cause a computer to carry out a method of configuring a claims issuance system to process identity information according to a specified evaluation process, the method comprising:
(A) receiving a specification describing at least one rule to be applied when processing identity claims as part of an evaluation process, the specification being in formatted as a rules-based language, each rule describing a condition and an action to be taken upon fulfillment of the condition;
(B) interpreting the specification received in the act (A) to determine a functional process for how to carry out the at least one rule;
(C) configuring the claims issuance system to carry out the functional process upon receiving input identity information;
(D) upon receipt of an input token comprising at least one input claim from a content consumer seeking proof of identity, carrying out the functional process to determine an output token comprising at least one output claim, the at least one output claim comprising identity information relating to the content consumer.

11. The at least one computer-readable storage medium of claim 10, wherein the condition is that two or more identity claims correspond to predetermined values.

12. The at least one computer-readable storage medium of claim 11, wherein the two or more identity claims include identity claims not received in the input token.

13. The at least one computer-readable storage medium of claim 10, wherein the action comprises retrieving additional identity claims from an external data store when the condition is met, the external data store being specified by the action.

14. The at least one computer-readable storage medium of claim 13, wherein the method further comprises:
receiving a communication protocol specification for the external data store, the communication protocol specification describing a manner in which information is to be requested and received from the external data store; and
configuring the claims issuance system to communicate with the external data store according to the communication protocol specification.

15. The at least one computer-readable storage medium of claim 10, wherein the action comprises generating at least one intermediate identity claim that is not output in the output token.

16. An apparatus adapted to act as an identity issuer in a system comprising a content consumer and a content provider, where the content provider requires identity information for the content consumer to provide content to the content consumer, and where the identity issuer provides identity information for the content consumer, the apparatus comprising:
at least one processor adapted to:
receive a specification describing at least one task to be carried out in processing identity information as part of an evaluation process, the specification describing a condition and an action to be taken upon fulfillment of the condition;
interpret the specification to determine a functional process for how to carry out the at least one task; and
configure the identity issuer to carry out the functional process upon receiving input identity information.

17. The apparatus of claim 16, wherein the at least one processor is further adapted to:
receive at least two communication protocol specifications for at least two external data stores, each communication protocol specification describing a manner in which information is to be requested and received from an associated external data store; and
configuring the identity issuer to communicate with the at least two external data stores according to the at least two communication protocol specification.

18. The apparatus of claim 17, wherein the action comprises retrieving additional identity information from an external data store when the condition is met, the external data store being specified by the action.

19. The apparatus of claim 16, wherein the action comprises generating at least one piece of intermediate identity information that is not output as output identity information.

20. The apparatus of claim 16, wherein the action comprises assembling an output token comprising output identity information, wherein the output identity information comprises at least some of the input identity information.
